(19) United States
(12) Patent Application Publication
(10) Pub. No.: US 2005/0028324 A1
(43) Pub. Date: Feb. 10, 2005

(54) Method of melting treatment of radioactive metals

(75) Inventors: Seiya Yamada, Naka-gun (JP); Masayuki Takeuchi, Naka-gun (JP); Tsutomu Koizumi, Naka-gun (JP); Kazuo Kusaba, Naka-gun (JP); Minoru Murata, Naka-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: MITSUBISHI MATERIAL CORPORATION, Tokyo (JP); Japan Nuclear Cycle Development Institute, Naka-gun (JP)

(21) Appl. No.: 10/632,791

(22) Filed: Aug. 4, 2003

(51) Int. Cl. C01D 3/20

(52) U.S. Cl. 23/308 R

(57) ABSTRACT

A method for treatment of uranium-containing wastes, which realizes the decontamination of steel-based metallic wastes such as carbon steel or stainless steel containing nuclear fuel materials such as uranium or plutonium, produced from nuclear facilities, simultaneously with the reduction of volume thereof. Spent nuclear fuel (uranium) 6, which is mixed with hull 5 as stainless-based metal, is separated from the stainless-based metal, through the separation of uranium that constitutes the spent nuclear fuel 6 as oxides by melting the stainless-based metal wastes.

### BACKGROUND OF THE INVENTION

1. Field of the Invention

The present invention relates to a method of melting treatment of radiation-contaminated or radioactive metals, particularly to a method of treatment of uranium-containing wastes, which performs the decontamination of steel-based metallic wastes such as carbon steel or stainless steel containing nuclear fuel materials such as uranium or plutonium, produced from nuclear facilities, simultaneously with the reduction of volume thereof.

2. Description of the Related Art

Nuclear facilities generate metallic wastes which are contaminated by nuclear fuel materials such as uranium or plutonium. Among these wastes, those having higher concentration of contamination are assumed to be stored in a deep geologic repository, which, however, results in enormous disposal cost. For this reason, so-called decontamination process for removing uranium or plutonium from these contaminated metallic wastes is performed first so as to lower the concentration of contamination of the wastes to non-regulated level, and then such wastes are disposed separately to reduce the costs.

Decontaminated wastes are stored by being packed into a drum, but as there is a limit in a volume of a storage facility therefor, methods of substantially reducing the amount of contaminated substances by separating the contaminated metallic wastes into contaminated substances and metals have been proposed in the past.

One example of such conventional methods for separating contaminated metallic wastes into contaminated substances and metals, is to add slag material such as calcia, silica, alumina or the like to metals that are contaminated by nuclear fuel materials, and then to separate nuclear fuel materials as oxides from the metallic components thereof to recover the same. One of the improvements of such conventional methods is disclosed in Japanese Examined Patent Publication No. 5-31759, which discloses a method of melting decontamination of radioactive metals, comprising the steps of adding slag materials consisting of basic inorganic oxides and acidic inorganic oxides to metals that are contaminated by nuclear fuel materials, and thermally melting the same to include the nuclear fuel material in the slag, wherein said acidic inorganic oxides are silic acid, and the basic inorganic oxides of which the basicity is between 1 and 2 are used.

By these decontamination methods using slag, metallic components and radioactive substances can be separated, thus achieving a volume reduction effect to a certain extent, stabilizing toxic substances and homogenizing solidified substances.

However, as these conventional treatment methods perform the separation process by confining radioactive substances such as uranium oxide in the slag, a sufficient amount of slag materials need to be added so that the slag containing uranium would necessarily reach a substantial amount. As the slag containing uranium must be treated in the same away as high-level contaminated wastes, these slag materials not only become secondary wastes but the separated metallic components thereof need to be treated, thus resulting in insufficient reduction of volume in the present situation.

One of representatives of metallic wastes contaminated by nuclear fuel substances such as uranium or plutonium is so-called “hull”. In general, spent nuclear fuel rods are filled in cladding tubes and put therein as rod-like elements. When treating such spent nuclear fuel rods, they are severed together with the cladding tubes, thus producing the wastes of the cladding tubes, i.e., “hull”. Whilst normal nuclear reactors employ zirconium alloy for such cladding tubes, fast-breeder reactors and the like employ steel-based metallic materials such as SUS316-based stainless materials, instead of zirconium alloys. Hulls produced after mechanical shredding of nuclear fuel otide are separated into metal pieces and nuclear fuels through magnetic separation or the like so that the metal pieces are disposed as radioactive wastes while nuclear fuels are reprocessed so as to be used as nuclear fuels again. Nevertheless, the nuclear fuels which were not fully separated by magnetic separation still remain in the metal pieces, which makes it difficult to dispose them as metal wastes, hindering the improvement of fuel recovery rate.

Accordingly, if nuclear fuel substances are able to be separated, decontaminated or recovered from the steel-based metal materials containing the nuclear fuel substances, and at the same time the volume thereof can be substantially reduced and the recovered metal materials are recyclable, then it would be advantageous in performing the treatment of metallic wastes that are contaminated by nuclear fuels.

### SUMMARY OF THE INVENTION

In view of the above problems, it is, therefore, an object of the present invention to provide a method for treatment of uranium-containing wastes, which attains the separation, decontamination and recovery of nuclear fuel substances from steel-based metal wastes such as carbon steel or stainless steel which contain uranium or plutonium produced from nuclear facilities, simultaneously with the reduction of volume thereof.

To attaint the object, a first aspect of the invention proposes a method for melting treatment of radioactive metals, said melting treatment being performed for separating steel-based metal and nuclear fuel substances from radioactive steel-based metal wastes, comprising the step of separating said nuclear fuel substances as oxide by melting said steel-based metallic wastes.

Accordingly, it is possible to separate the nuclear fuel substances from stainless-based metallic components without using slag materials, and thus the separated nuclear fuel material, which is in extremely small quantities, containing no slag materials, can be recycled by reprocessing the same as it is. Further, as the stainless-based metallic component contains such an extremely low uranium residue that wastes disposition method and management thereof can be simplified. Besides, such metallic component can be recycled as a resource, depending on cases. Thus way, the volume of secondary wastes can be reduced drastically. In addition, as the above-described method basically requires a heating furnace only, the simplification of the treatment process is achieved.

According to a second aspect of the invention, there is proposed a method for melting treatment of radioactive metals as set forth in the first aspect, in which the steel-based metal is hull made of stainless alloy. Thus, the treatment of hull made of stainless steel can be performed effectively.

According to a third aspect of the invention, there is proposed a method for melting treatment of radioactive metals as set forth in the foregoing aspects, in which the nuclear fuel substances are separated as oxides while suppressing a percentage content of aluminum through the melting treatment of the steel-based wastes. Accordingly, the nuclear fuel substances can be decontaminated effectively.

### BRIEF DESCRIPTION OF THE DRAWINGS

For more complete understanding of the present invention, reference is now made to the following description taken in conjunction with the accompanying drawing, in which:

FIG. 1 is a schematic diagram showing a method of melting treatment of radioactive metals of the present invention.

### DETAILED DESCRIPTION OF THE PREFERRED EMBODIMENTS

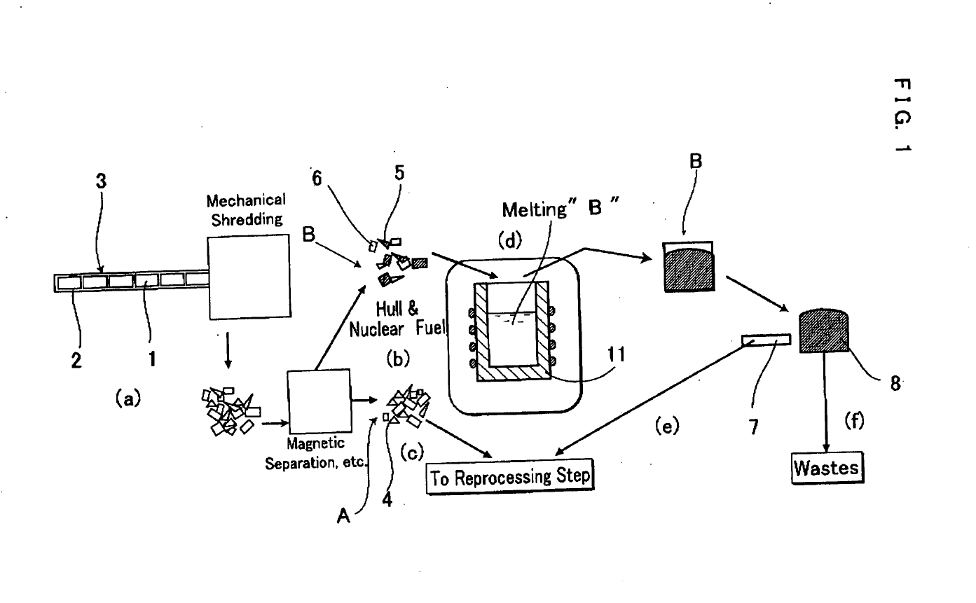

Hereunder is a description of an embodiment of the present invention with reference to FIG. 1.

Steel-based metallic wastes to be treated according to the present invention are wastes of metals such as carbon steel or stainless steel, contaminated by radioactive nuclear fuel substances such as uranium or plutonium. When decontaminating metallic wastes contaminated by uranium or the like, slag materials such as calcia, silica, alumina or the like are normally added thereto so that uranium is confined in the slag as uranium oxide to thereby perform decontamination. However, the resultant slag become secondary wastes, which has thus far been a main cause of unsuccessful reduction of wastes' volume. However, extensive research by the present inventors has led to a surprising finding that nuclear fuel materials such as uranium or the like are able to form slag as oxide, alone, without adding slag materials, so that they are separated from steel-based metals.

Next is a description of a method of treatment of the above-mentioned steel-based metal wastes according to the present invention, taking an example of the decontamination and recover of uranium as nuclear fuel substance from SUS316 stainless made hulls.

Referring to FIG. 1, spent nuclear fuel 1 is placed in a cladding tube 2 made of SUS316 stainless steel so as to be kept therein in a state of a spent fuel rod 3, which is, together with the cladding tube 2, subjected to mechanical shredding, as shown in FIG. 1(a). Subsequently, the wastes thus shredded are separated into wastes A consisting of the spent nuclear fuel 4 only and wastes B including a mixture of hulls 5 as shredded pieces of the cladding tube 2 and magnetically inseparable spent nuclear fuels 6, as shown in FIG. 1(b). The wastes A consisting of the spent nuclear fuels 4 only are recycled through reprocessing steps, as shown in FIG. 1(c).

On the other hand, the wastes B including a mixture of the hulls 5 and the spent nuclear fuels 6 are subjected to melting separation treatment, as shown in FIG. 1(d). In other words, the wastes B are put in a melting furnace 11 and then heated up to a melting point thereof or above, more specifically heated to 1500-1650 degrees centigrade. Ambient atmospheric air in this case may be an ordinary atmospheric air, or otherwise, the one into which a slight amount of argon gas is introduced, so that oxygen in the ambient gets involved in this melting bath so as to oxidize uranium, thus forming slag by this uranium oxide thus produced. In the meantime, in the event that uranium already exists as oxide, then uranium does not need to be oxidized, and thus the existing uranium oxide forms slag at it is, so that uranium component 7 and metal component 8 are formed as different layers, respectively.

After the uranium component 7 and the metal component 8 are separated in the above-mentioned moner, the uranium component 7 is recycled as nuclear fuel through a reprocessing step, as shown in FIG. 1(e), while only the stainless-based metal component 8 is treated as wastes, as shown in FIG. 1(f).

The above-mentioned processing is also advantageous in that wastes disposition method or management thereof can be simplified when disposing of them as wastes, as uranium residues in the stainless-based metal component 8 is in the order of a few ppm or below. Further, as it is possible to recover uranium by condensing uranium only in the uranium component 7, not only drastic reduction of volume is realized as compared with conventional recovery in a state of slag, but also the quantity of radioactive wastes can be reduced substantially, as it becomes recyclable through reprocessing in a reprocessing step.

In the meantime, if the percentage content of aluminum contained in the wastes B is high, uranium becomes less likely to be oxidized at the time of melting separation treatment. Thus, it is necessary to suppress an aluminum content contained in the wastes B, by using the cladding tube 2 or the like that is low in aluminum content.

As described in the foregoing, the method for melting treatment of radioactive according to the invention is a method for separating the spent nuclear fuel 6 from the stainless-based metallic wastes A including a mixture of the hull 5 as stainless-based metal and the spent nuclear fuel 6, wherein the stainless-based metallic wastes are melt so that uranium that construct the spent nuclear fuel 6 is separated as oxide. Accordingly, it is possible to separate the stainless-based metallic component from the uranium component without using slag materials, whereby the uranium component can be recycled by reprocessing the same as it is. Further, as the stainless-based metallic component contains such an extremely low uranium residue that wastes disposition method and management thereof can be simplified. Besides, such metallic component can be recycled as a resource, depending on cases. It should be noted that as any of the above-mentioned treatments is performed in a dry system, it indicates such a high productivity of facility that it is suitable for mass disposition. Moreover, as the decontamination treatment and volume reduction treatment are performed simultaneously, the process therefor is so simple that they require less manpower. Also, the treatment cost is advantageously low since no slag material or flux is used. In addition to the foregoing, since the method of the invention basically requires the melting furnace only as a treatment device, the simplification of the treatment device and process is achieved.

The method of treatment according to the invention is suitable for hull made of stainless-based alloy, which, however, should not be limited thereto, but is applicable to the treatment of steel-based metallic wastes which are contaminated by various kinds of nuclear fuel substances. Although uranium is taken as an example in the foregoing embodiment, the invention is applicable to other nuclear fuels such as plutonium.

Nest is a description of an embodiment of the invention with which the present invention is described in further detail.

A First Embodiment:

One percentage by weight of uranium (in terms of uranium oxide powder) was added to SUS316 fragments, which were mixed to prepare test samples. Then, each test sample was put in a melting furnace, and heated at 1,600 degrees centigrade until it is wholly molten. The test sample thus molten was retained in a molten state for 30 minutes, and then cooled, solidified and taken out. As a result, it was separated into an accumulation layer of SUS316 steel ingots and that of uranium particles.

Four samples were taken from the SUS316 metallic layer, and dissolved with acid or the like. The measurement of uranium residual level in the samples by ICP analysis revealed that all of the four samples indicated uranium residue were in a range of from 0.5 ppm to 1 ppm.

It should be noted that the present invention should not be limited to the above-mentioned embodiment but various modifications are possible within the scope of the invention.

1. A method for melting treatment of radioactive metals, said melting treatment being performed for separating steel-based metal and nuclear fuel substances from radioactive steel-based metal wastes, comprising the step of separating said nuclear fuel substances as oxide by melting said steel-based metallic wastes.

2. A method for melting treatment of radioactive metals according to claim 1, wherein said steel-based metal is hull made of stainless alloy.

3. A method for melting treatment of radioactive metals according to claim 1, wherein said nuclear fuel substances are separated as oxides while suppressing a percentage content of aluminum through the said melting of the steel-based wastes.

4. A method for melting treatment of radioactive metals according to claim 2, wherein said nuclear fuel substances are separated as oxides while suppressing a percentage content of aluminum through the said melting of the steel-based wastes.

5. A method for melting treatment of radioactive metals according to claim 1, wherein said nuclear fuel substances are uranium.

6. A method for melting treatment of radioactive metals according to claim 1, wherein said steel-based metal wastes are melted by being heated to a temperature not lower than a melting point thereof.

7. A method for melting treatment of radioactive metals according to claim 6, wherein said temperature is in a range of from 1500 to 1650 degrees centigrade.

8. A method for melting treatment of radioactive metals according to claim 1, wherein an atmospheric air or the one including a slight amount of an argon gas is introduced when melting said steel-based metal wastes.

9. A method for melting treatment of radioactive metals according to claim 1, wherein said nuclear fuel substances are separated as oxides, and then recycled through a reprocessing step.
